(19) United States
(12) Patent Application Publication
(10) Pub. No.: US 2010/0142372 A1
(43) Pub. Date: Jun. 10, 2010

(54) Method And Apparatus For Use In A Communications Network

(76) Inventors: Christer Boberg, Tungelsta (SE); Anders Lindgren, Alvsjo (SE); Hans Lindgren, Alvsjo (SE); Jan Holm, Orbyhus (SE); Henrik Albertsson, Stockholm (SE)

Correspondence Address: ERICSSON INC., 6300 LEGACY DRIVE, M/S EVR 1-C-11, PLANO, TX, 75024, US

(21) Appl. No.: 12/593,906

(22) PCT Filed: Mar. 29, 2007
(86) PCT No.: PCT/EP2007/053043

§ 371 Date: Jan. 4, 2010

(51) Int. Cl. H04W 24/00; H04W 4/00

(52) U.S. Cl. 370/230; 370/338; 370/254

(57) ABSTRACT

A method is disclosed for use in a Universal Mobile Telecommunications System network comprising an IP Multimedia Subsystem. The method comprises receiving node status information relating to a first node of the network which indicates an occurrence of an event associated with the first node, determining the existence of a network association established between the first node and a second node of the network that would be adversely affected by the occurrence of the event, and causing the network association to be terminated, thereby allowing a new network association between the first and second nodes to be established in its place.

### TECHNICAL FIELD

The present invention relates to a method and apparatus for use in a communications network, for example a Universal Mobile Telecommunications System having an IP Multimedia Subsystem.

### BACKGROUND

IP Multimedia services provide a dynamic combination of voice, video, messaging, data, etc. within the same session. By growing the number of basic applications and the media which it is possible to combine, the number of services offered to the end users will grow, and the inter-personal communication experience will be enriched. This will lead to a new generation of personalised, rich multimedia communication services, including so-called “combinational IP Multimedia” services.

The UMTS (Universal Mobile Telecommunications System) is a third generation wireless system designed to provide higher data rates and enhanced services to subscribers. UMTS is a successor to the Global System for Mobile Communications (GSM), with an important evolutionary step between GSM and UMTS being the General Packet Radio Service (GPRS). GPRS introduces packet switching into the GSM core network and allows direct access to packet data networks (PDNs). This enables high-data rate packets switch transmissions well beyond the 64 kbps limit of ISDN through the GSM call network, which is a necessity for UMTS data transmission rates of up to 2 Mbps. UMTS is standardised by the 3^{rd} Generation Partnership Project (3GPP) which is a conglomeration of regional standards bodies such as the European Telecommunication Standards Institute (ETSI), the Association of Radio Industry Businesses (ARIB) and others. See 3GPP TS 23.002 for more details.

The UMTS architecture includes a subsystem known as the IP Multimedia Subsystem (IMS) for supporting traditional telephony as well as new IP multimedia services (3GPP TS 22.228, TS 23.228, TS 24.229, TS 29.228, TS 29.229, TS 29.328 and TS 29.329 Releases 5 to 7). IMS provides key features to enrich the end-user person-to-person communication experience through the use of standardised IMS Service Enablers, which facilitate new rich person-to-person (client-to-client) communication services as well as person-to-content (client-to-server) services over IP-based networks. The IMS is able to connect to both PSTN/ISDN (Public Switched Telephone Network/Integrated Services Digital Network) as well as the Internet.

The IMS makes use of the Session Initiation Protocol (SIP) to set up and control calls or sessions between user terminals (or user terminals and application servers). The Session Description Protocol (SDP), carried by SIP signalling, is used to describe and negotiate the media components of the session. Whilst SIP was created as a user-to-user protocol, IMS allows operators and service providers to control user access to services and to charge users accordingly. The 3GPP has chosen SIP for signalling between a User Equipment (UE) and the IMS as well as between the components within the IMS.

Specific details of the operation of the UMTS communications network and of the various components within such a network can be found from the Technical Specifications for UMTS that are available from http://www.3gpp.org. Further details of the use of SIP within UMTS can be found from the 3GPP Technical Specification TS 24.228 V5.8.0 (2004-03).

FIG. 1 of the accompanying drawings illustrates schematically how the IMS fits into the mobile network architecture in the case of a GPRS/PS access network (IMS can of course operate over other access networks). Call/Session Control Functions (CSCFs) operate as SIP proxies within the IMS. The 3GPP architecture defines three types of CSCFs: the Proxy CSCF (P-CSCF) which is the first point of contact within the IMS for a SIP terminal; the Serving CSCF (S-CSCF) which provides services to the user that the user is subscribed to; and the Interrogating CSCF (I-CSCF) whose role is to identify the correct S-CSCF and to forward to that S-CSCF a request received from a SIP terminal via a P-CSCF.

A user registers with the IMS using the specified SIP REGISTER method. This is a mechanism for attaching to the IMS and announcing to the IMS the address at which a SIP user identity can be reached. In 3GPP, when a SIP terminal performs a registration, the IMS authenticates the user, and allocates a S-CSCF to that user from the set of available S-CSCFs. Whilst the criteria for allocating S-CSCFs is not specified by 3GPP, these may include load sharing and service requirements. It is noted that the allocation of an S-CSCF is key to controlling (and charging for) user access to IMS-based services. Operators may provide a mechanism for preventing direct user-to-user SIP sessions which would otherwise bypass the S-CSCF.

During the registration process, it is the responsibility of the I-CSCF to select an S-CSCF if a S-CSCF is not already selected. The I-CSCF receives the required S-CSCF capabilities from the home network's Home Subscriber Server (HSS), and selects an appropriate S-CSCF based on the received capabilities. [It is noted that S-CSCF allocation is also carried out for a user by the I-CSCF in the case where the user is called by another party, and the user is not currently allocated an S-CSCF.] When a registered user subsequently sends a session request to the IMS, the P-CSCF is able to forward the request to the selected S-CSCF based on information received from the S-CSCF during the registration process.

Within the IMS service network, Application Servers (aSs) are provided for implementing IMS service functionality. Application Servers provide services to end-users in an IMS system, and may be connected either as end-points over the 3GPP defined Mr interface, or “linked in” by an S-CSCF over the 3GPP defined ISC interface. In the latter case, Initial Filter Criteria (IFC) are used by an S-CSCF to determine which Applications Servers should be “linked in” during a SIP Session establishment. Different IFCs may be applied to different call cases. The IFCs are received by the S-CSCF from an HSS during the IMS registration procedure as part of a user's User Profile. Certain Application Servers will perform actions dependent upon subscriber identities (either the called or calling subscriber, whichever is “owned” by the network controlling the Application Server). For example, in the case of call forwarding, the appropriate (terminating) application server will determine the new terminating party to which a call to a given subscriber will be forwarded. In the case that an IFC indicates that a SIP message received at the S-CSCF should be forwarded to a particular SIP AS, that AS is added into the message path. Once the SIP message is returned by the AS to the S-CSCF, it is forwarded on towards its final destination, or forwarded to another AS if this is indicated in the IFCs.

The applicant has appreciated the following problem with the situation as it is currently specified.

IMS is a solution full with possibilities for new types of services with a large range of flexibility in deployment. However, this flexibility also leads to an increased complexity in the system, especially as it is designed to host multiple types of applications.

One area that has been explored to a limited extent is the technology and solutions required in order to address situations that may occur when a node goes down or is restarted.

The basic problem is that there is no existing generic solution to inform an IMS client that a server, for example, has been restarted, and hence that the client needs to log in again or needs to recreate an ongoing session.

This is particularly important for services such as presence where a subscription can exist for a long period of time and where such a failure in the system will not be known by the client until it tries to re-subscribe. The general desire is also to increase the expiry times as much as possible to improve performance in the network.

It is desirable to address the above-identified issue.

### SUMMARY

According to a first aspect of the present invention there is provided a method for use in a Universal Mobile Telecommunications System network comprising an IP Multimedia Subsystem, the method comprising receiving node status information relating to a first node of the network which indicates an occurrence of an event associated with the first node, determining the existence of a network association established between the first node and a second node of the network that would be adversely affected by the occurrence of the event, and causing the network association to be terminated, thereby allowing a new network association between the first and second nodes to be established in its place.

The method may comprise sending a message to the second node which indicates that the association is to be terminated.

The determination may be made at least partly by the second node.

The method may comprise sending a message to the second node comprising information relating to the first node, and using the first node information at the second node to determine the existence of a network association between the first and second nodes that would be affected by the occurrence of the event.

The message may be a SIP Multicast message, such as a SIP MESSAGE Request, sent to the second and other nodes of the network.

The first node information may comprise contact information for the first node.

The method may comprise using a contact header of the message at least in part to make the determination.

The first node information may comprise the SIP Uniform Resource Identifier, URI, of the first node.

The method may comprise causing a timing of the re-establishment of the network association between the first and second nodes to be determined at least partly on a random basis, thereby easing system load where a number of network associations relating to other nodes of the network are being re-established with the first node in view of the event occurrence.

The method may comprise sending a time window to the second node, and causing at least the starting of the re-establishment within the time window.

The event may be one that causes at least partial loss of information required to maintain the network association.

The event may relate to at least a partial failure of the second node.

The event may relate to at least a partial unavailability of the second node.

The event may relate to the restarting of the second node.

The network association may comprise a communication session between the first and second node.

The message may be a SIP BYE message.

The network association may comprise a subscription between the first and second node.

The message may be a final SIP NOTIFY message.

The network association may comprise a Security Association between the first and second node.

The network association may comprise a PDP context between the first and second node

The method may comprise making the determination with reference to route information.

The method may comprise making the determination on the basis of information stored locally at the node performing the method.

The first node may comprise an Application Server.

The first node may comprise a Serving Call Session Control Function.

The method may be performed at a Proxy Call Session Control Function.

The first node may comprise a Proxy Call Session Control Function.

The method may be performed at a Gateway GPRS Support Node.

The method may be performed at the second node.

The node status information may be received in a Session Initiation Protocol, SIP, Request.

The SIP Request may comprise a Request Uniform Resource Identifier, or Request-URI, which identifies the SIP Request as comprising node status information and/or which identifies the intended recipients of the node status information.

The method may comprise determining the intended recipients from the received Request URI.

The method may comprise forwarding the status information to the determined recipients.

The method may comprise using the status information at the receiving node if the receiving node is determined to be one of the intended recipients.

The method may comprise referring to an Initial Filter Criteria associated with the Request URI to determine the intended recipients.

The method may comprise referring to a Dynamic Name Server to determine the intended recipients from the Request URI.

The method may comprise determining the intended recipients in dependence upon a previously-received SIP SUBSCRIBE Request.

The SIP Request may be a SIP PUBLISH Request.

The method may comprise using the time to live information from the SIP PUBLISH Request to infer further information about the node status.

The SIP Request may be a SIP MESSAGE Request.

The method may comprise storing the node status relating to those nodes identified by the SIP Request URI.

According to a second aspect of the present invention there is provided an apparatus for use in a Universal Mobile Telecommunications System network comprising an IP Multimedia Subsystem, the apparatus comprising means for receiving node status information relating to a first node of the network which indicates an occurrence of an event associated with the first node, means for determining the existence of a network association established between the first node and a second node of the network that would be adversely affected by the occurrence of the event, and means for causing the network association to be terminated, thereby allowing a new network association between the first and second nodes to be established in its place.

According to a third aspect of the present invention there is provided a program for controlling an apparatus to perform a method according to the first aspect of the present invention or which, when loaded into an apparatus, causes the apparatus to become an apparatus according to the second aspect of the present invention. The program may be carried on a carrier medium. The carrier medium may be a storage medium. The carrier medium may be a transmission medium.

According to a fourth aspect of the present invention there is provided an apparatus programmed by a program according to the third aspect of the present invention.

According to a fifth aspect of the present invention there is provided a storage medium containing a program according to the third aspect of the present invention.

### BRIEF DESCRIPTION OF THE DRAWINGS

FIG. 1, discussed hereinbefore, illustrates schematically the integration of an IP Multimedia Subsystem into a 3G mobile communications system;

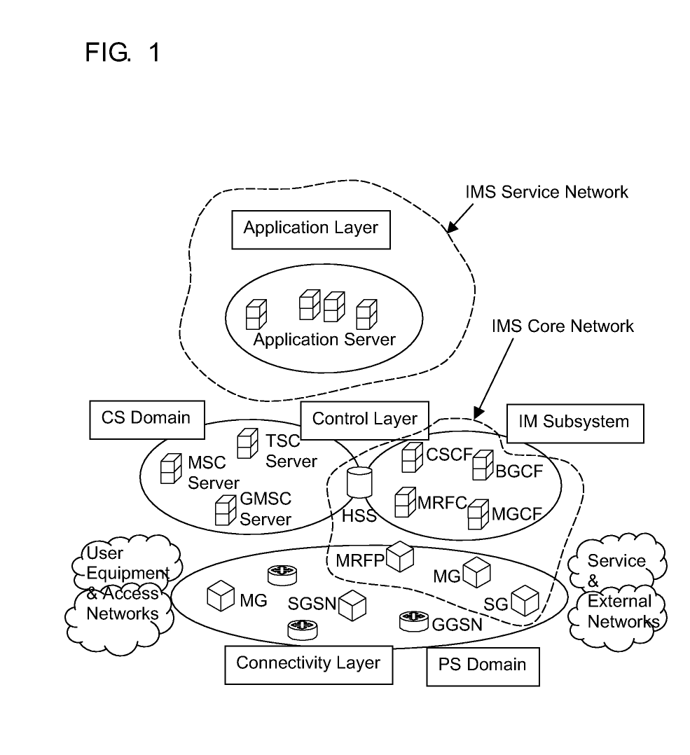

FIG. 2 is a block diagram for use in providing an overview of an embodiment of the present invention; and

FIGS. 3 and 4 are block diagrams for use in illustrating a first example embodying the present invention.

### DETAILED DESCRIPTION

An embodiment of the present invention combines a mechanism for distributing node status information and the fact that some network nodes (for example, a P-CSCF) hold information concerning those client nodes (for example, UEs) that hold a session to a particular node (for example, an Application Server). By this, the P-CSCF is able to reset the session between the client and the node when it detects that the node has become unavailable, for example due to a temporary failure.

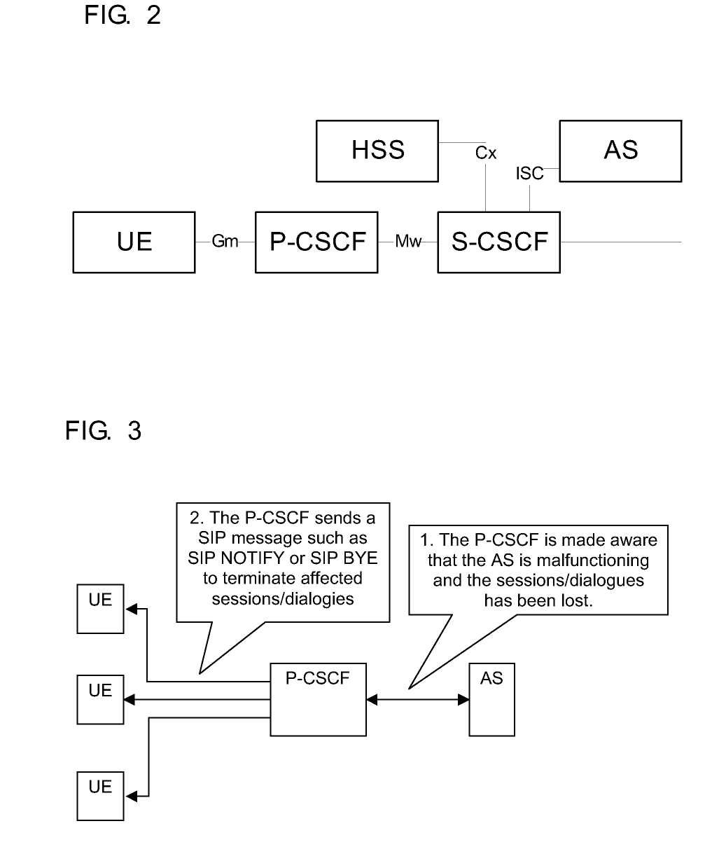

In the example illustrated in FIG. 2, the P-CSCF, S-CSCF and AS nodes are each included in the distribution of status information from these nodes. At regular intervals (or other intervals determined by the particular method used) the nodes would distribute status information that may include information about the node restarting, and so on. More information on this, and a suitable mechanism for distributing node status information in an embodiment of the present invention is described in our co-pending PCT patent application no. [agent's ref P54319WO], whose whole content is hereby incorporated herein by reference.

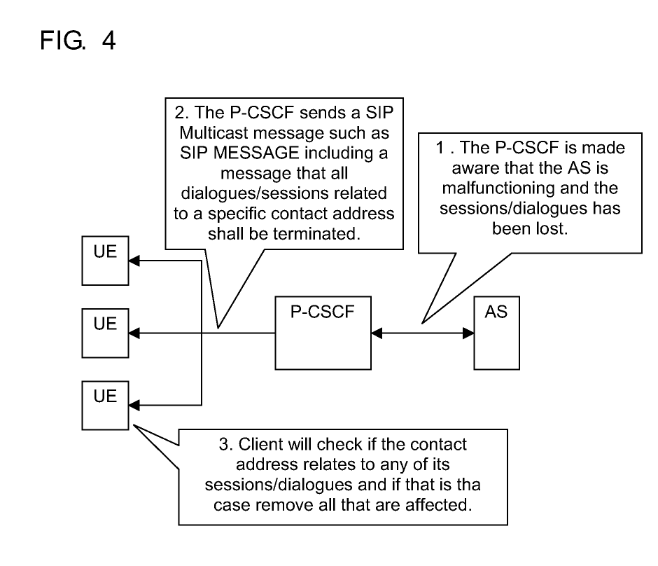

A first specific example will now be described with reference to FIGS. 3 and 4. The first example relates to a scenario where an Application Server has been forced, for some reason, to undergo a restart.

In the case of a failure of the Application Server, for example resulting in a restart, there might be many UEs with “hanging” sessions/dialogues, still assuming they are connected to the AS. However, since the AS has restarted it has lost all its session data.

In order to reset the sessions hanging in the UEs, the AS includes status information indicating that it has been restarted in its status information message (step 1 of FIG. 3), which is received by the P-CSCF.

Part of the normal functionality of the P-CSCF is to hold information about all active sessions/dialogues. It can now loop through this information in order to find all sessions/dialogues to the affected AS. The P-CSCF has knowledge about the route information, so by checking the route information for all established sessions/dialogues it is able to detect which ones are affected by the restarted/malfunctioning node.

Once the P-CSCF has found any sessions to the restarted AS it sends a SIP message to the UEs in order to reset the affected sessions (step 2 of FIG. 3). Also, the P-CSCF marks as invalid its own dialogs involving the restarting AS, and clears them to free memory if required.

One option is for the P-CSCF to use a proper SIP method such as a final SIP NOTIFY to terminate an established subscription, or a SIP BYE to terminate an established session. This is what is illustrated in FIG. 3.

An alternative is to use SIP Multicast to inform all clients about the fact that the AS node has restarted. This is illustrated in FIG. 4. The Multicast message (such as SIP MESSAGE) will then include the contact information about the restarted node so that the client can determine if the restarted node affects that clients established dialogues/sessions or not. Where there is a proxy node between the P-CSCF and the target node (included in the contact information), the routing information must be known by the terminal, which is normally not the case. But in the case where the restarting node is an AS to where the session/dialogue is established, the client can know by way of the contact header.

In the first example, the restart of an Application Server serves as the example of how a mechanism according to an embodiment of the present invention can be triggered. However, the invention is not limited to this.

A second example will now be described. The second example relates to a scenario where an S-CSCF has been forced, for some reason, to undergo a restart.

In the case of a failure of the S-CSCF, for example resulting in a restart, there might be many UEs with registrations that are no longer valid.

In such a situation, the P-CSCF notifies the UEs that they should register again.

The P-CSCF summarizes the information. It sends one or several SIP requests outside a dialog, for example a MESSAGE. A single request could be sent if a multicast mechanism is used. In one example, the SIP request contains the SIP URI (Uniform Resource Identifier) of the S-CSCF that has failed, and a time window. The UE has information concerning the originating S-CSCF from the Service-Route header from the registration procedure. The UE can compare the S-CSCF name from the received SIP request with the S-CSCF from the Service-Route. If they match, the affected UEs should register again. A UE should use a random value up to the time window to spread the load on the system for the registrations as a result of this request.

Also, the P-CSCF marks as invalid its own dialogs involving the restarting S-CSCF, and clears them to free memory if required.

A third example will now be described. The third example relates to a scenario where a P-CSCF has been forced, for some reason, to undergo a restart.

In the case of a failure of the P-CSCF, for example resulting in a restart, there might be many UEs with registrations that are no longer valid, and also lost security associations.

In a case where the GGSN (Gateway GPRS Support Node) has a vertical interface, it is able to recognize that the P-CSCF has restarted.

The GGSN could then deactivate all affected PDP (Packet Data Protocol) contexts. As an alternative, a new multicast or broadcast message could be defined to reduce the load on the system. This new message should then instruct all affected UEs to register again to the system.

On a general level, if a SIP Node receives information about another SIP Node that it has a connection to via a SIP dialog, but is not a P-CSCF, it does not need to inform the

UEs as the P-CSCF (in the first and second examples above) or GGSN (in the third example above) will take care of informing them, it can use the Node state information to mark the SIP dialogs involving the restarted node as invalid and clear them to free memory if needed. If all SIP nodes involved in SIP dialogs acts like this, the use of memory in a network's SIP nodes will be more efficient.

An embodiment of the present invention enables a way for the network to reset “hanging” SIP sessions. In this way, the overall system behaviour, as well as the usability of the system, will improve, and the impact of a temporary failure in a node will be reduced. It also makes it possible to reduce the robustness requirements on different ASs in the network, which reduces the overall cost.

It will be appreciated that operation of one or more of the above-described components can be controlled by a program operating on the device or apparatus. Such an operating program can be stored on a computer-readable medium, or could, for example, be embodied in a signal such as a downloadable data signal provided from an Internet website. The appended claims are to be interpreted as covering an operating program by itself, or as a record on a carrier, or as a signal, or in any other form.

It will also be appreciated by the person of skill in the art that various modifications may be made to the above-described embodiments without departing from the scope of the present invention as defined by the appended claims. In particular, it will be appreciated that, although described in relation to a Universal Mobile Telecommunications System having an IP Multimedia Subsystem, the present invention is also applicable to other types of network.

1. A method for use in a Universal Mobile Telecommunications System network comprising an IP Multimedia Subsystem, the method comprising
receiving node status information relating to a first node of the network which indicates an occurrence of an event associated with the first node,
determining the existence of a network association established between the first node and a second node of the network that would be adversely affected by the occurrence of the event, and
causing the network association to be terminated, thereby allowing a new network association between the first and second nodes to be established in its place.

2. The method as claimed in claim 1, comprising sending a message to the second node which indicates that the association is to be terminated.

3. The method as claimed in claim 1, wherein the determination is made at least partly by the second node.

4. The method as claimed in claim 3, comprising:
sending a message to the second node comprising information relating to the first node, and
using the first node information at the second node to determine the existence of a network association between the first and second nodes that would be affected by the occurrence of the event.

5. The method as claimed in claim 4, wherein the message is a SIP Multicast message, such as a SIP MESSAGE Request, sent to the second and other nodes of the network.

6. The method as claimed in claim 4, wherein the first node information comprises contact information for the first node.

7. The method as claimed in claim 4, comprising using a contact header of the message at least in part to make the determination.

8. The method as claimed in claim 4, wherein the first node information comprises the SIP Uniform Resource Identifier, URI, of the first node.

9. The method as claimed in claim 1, comprising causing a timing of the re-establishment of the network association between the first and second nodes to be determined at least partly on a random basis, thereby easing system load where a number of network associations relating to other nodes of the network are being reestablished with the first node in view of the event occurrence.

10. The method as claimed in claim 9, comprising sending a time window to the second node, and causing at least the starting of the re-establishment within the time window.

11. The method as claimed in claim 1, wherein the event is one that causes at least partial loss of information required to maintain the network association.

12. The method as claimed in claim 1, wherein the event relates to at least a partial failure of the second node.

13. The method as claimed in claim 1, wherein the event relates to an at least partial unavailability of the second node.

14. The method as claimed in claim 1, wherein the event relates to the restarting of the second node.

15. The method as claimed in claim 2, wherein the network association comprises a communication session between the first and second node.

16. The method as claimed in claim 15, wherein the message is a SIP BYE message.

17. The method as claimed in claim 2, wherein the network association comprises a subscription between the first and second node.

18. The method as claimed in claim 17, wherein the message is a final SIP NOTIFY message.

19. The method as claimed in claim 1, wherein the network association comprises a Security Association between the first and second node.

20. The method as claimed in claim 1, wherein the network association comprises a PDP context between the first and second node

21. The method as claimed in claim 1, comprising making the determination with reference to route information.

22. The method as claimed in claim 1, comprising making the determination on the basis of information stored locally at the node performing the method.

23. The method as claimed in claim 1, wherein the first node comprises an Application Server.

24. The method as claimed in claim 1, wherein the first node comprises a Serving Call Session Control Function.

25. The method as claimed in claim 1, wherein the method is performed at a Proxy Call Session Control Function.

26. The method as claimed in claim 1, wherein the first node comprises a Proxy Call Session Control Function.

27. The method as claimed in claim 26, wherein the method is performed at a Gateway GPRS Support Node.

28. The method as claimed in claim 1, wherein the method is performed at the second node.

29. The method as claimed in claim 1, wherein the node status information is received in a Session Initiation Protocol, SIP, Request.

30. The method as claimed in claim 29, wherein the SIP Request comprises a Request Uniform Resource Identifier, or Request-URI, which identifies the SIP Request as comprising node status information and/or which identifies the intended recipients of the node status information.

31. The method as claimed in claim 30, comprising determining the intended recipients from the received Request URI.

32. The method as claimed in claim 31, comprising forwarding the status information to the determined recipients.

33. The method as claimed in claim 31, comprising using the status information at the receiving node when the receiving node is determined to be one of the intended recipients.

34. The method as claimed in claim 31, comprising referring to an Initial Filter Criteria associated with the Request URI to determine the intended recipients.

35. The method as claimed in claim 31, comprising referring to a Dynamic Name Server to determine the intended recipients from the Request URI.

36. The method as claimed in claim 31, comprising determining the intended recipients in dependence upon a previously-received SIP SUBSCRIBE Request.

37. The method as claimed in claim 29, wherein the SIP Request is a SIP PUBLISH Request.

38. The method as claimed in claim 37, comprising using the time to live information from the SIP PUBLISH Request to infer further information about the node status.

39. The method as claimed in claim 29, wherein the SIP Request is a SIP MESSAGE Request.

40. The method as claimed in claim 29, comprising storing the node status relating to those nodes identified by the SIP Request URI.

41. An apparatus for use in a Universal Mobile Telecommunications System network comprising an IP Multimedia Subsystem, the apparatus comprising
means for receiving node status information relating to a first node of the network which indicates an occurrence of an event associated with the first node,
means for determining the existence of a network association established between the first node and a second node of the network that would be adversely affected by the occurrence of the event, and
means for causing the network association to be terminated, thereby allowing a new network association between the first and second nodes to be established in its place.

42-48. (canceled)
